(19) United States
(12) Patent Application Publication
(10) Pub. No.: US 2017/0297180 A1
(43) Pub. Date: Oct. 19, 2017

(54) QUICK RELEASE STRUCTURE OF T-SHAPED RATCHET WRENCH

(71) Applicant: Jun-Tsai Shyu, Taichung (TW)

(72) Inventor: Jun-Tsai Shyu, Taichung (TW)

(21) Appl. No.: 15/099,597

(22) Filed: Apr. 15, 2016

(51) Int. Cl. B25B 23/00; B25B 13/46

(52) U.S. Cl. CPC B25B 23/0035; B25B 13/463

(57) ABSTRACT

A quick release structure of a T-shaped ratchet wrench, and the ratchet wrench being comprised of a transverse force applying handle and a longitudinal acting handle, and a ratchet steering and a driving mechanism being installed at a junction of the two handles and provided for controlling a force applying direction, wherein a substantially polygonal plug end of the acting handle has a quick release structure comprising a sliding sleeve, an elastic member, a buckle, a top shaft and a latching bead, so that the sliding sleeve may be displaced to prop out the latching bead or sink the latching bead to achieve the effect of plugging an external connected assembling member securely or releasing the external connected assembling member quickly.

### BACKGROUND OF THE INVENTION

### 1. Fields of the Invention

The present invention relates to a quick release structure of a T-shaped ratchet wrench which may be connected to or separated from an external connected assembling member easily and quickly by a simple and easy operation to achieve the effects of a secured connection or a quick release.

### 2. Description of the Related Art

In most ratchet wrenches, a plug acting end (generally in a polygonal shape such as a tetragonal shape) is externally connected to an auxiliary external assembling member such as a socket or a screwdriver head of various different sizes (depending on the operation), so that a screw with specific size and shape can be rotated successfully, and the scope of applicability of the ratchet wrench can be extended fully.

However, many products of this sort do not come with any auxiliary mechanism installed between the plug acting end and the external connected assembling member for preventing the plug acting end and the external connected assembling member from falling out or missing unexpectedly. As a result, the connected assembling member often falls out unexpectedly, and thus making the operation of the ratchet wrenches very inconvenient. If there is a foreign substance or a discrepancy between the plug acting end and the external connected assembling member, the connection of the two may become too tight and the plug acting end and the external connected assembling member cannot be separated easily. Obviously, such ratchet wrenches cause tremendous inconvenience to users and requires further improvements.

### SUMMARY OF THE INVENTION

An object of the invention is to provide a quick release structure of T-shaped ratchet wrench in which a simple controlled latching bead is applied to tighten or release the external connected assembling member effectively and prevent the plug acting end and the assembling member from falling out or missing.

According to the invention, a substantially polygonal plug end of the acting handle has a quick release structure comprising a sliding sleeve, an elastic member, a buckle, a top shaft and a latching bead, so that the sliding sleeve may be displaced to prop out the latching bead or sink the latching bead to achieve the effect of plugging an external connected assembling member securely or releasing the external connected assembling member quickly.

### BRIEF DESCRIPTION OF THE DRAWINGS

The accomplishment of this and other objects of the invention will become apparent from the following description and its accompanying drawings of which:

FIG. 1 is an exploded view of the present invention;

FIG. 2 is a perspective view of the present invention;

FIG. 3 is a partial cross-sectional view of the present invention; and

FIG. 4 is a schematic view of an operation of the present invention.

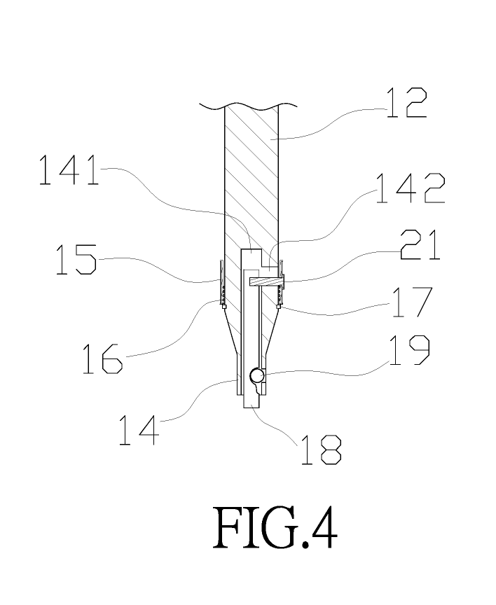

### DETAILED DESCRIPTION OF THE PREFERRED EMBODIMENT

The present invention will now be described in more detail hereinafter with reference to the accompanying drawings that show various embodiments of the invention.

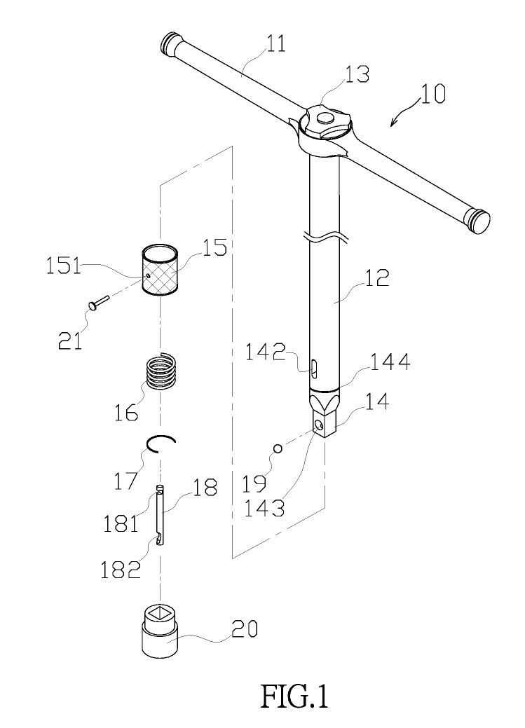

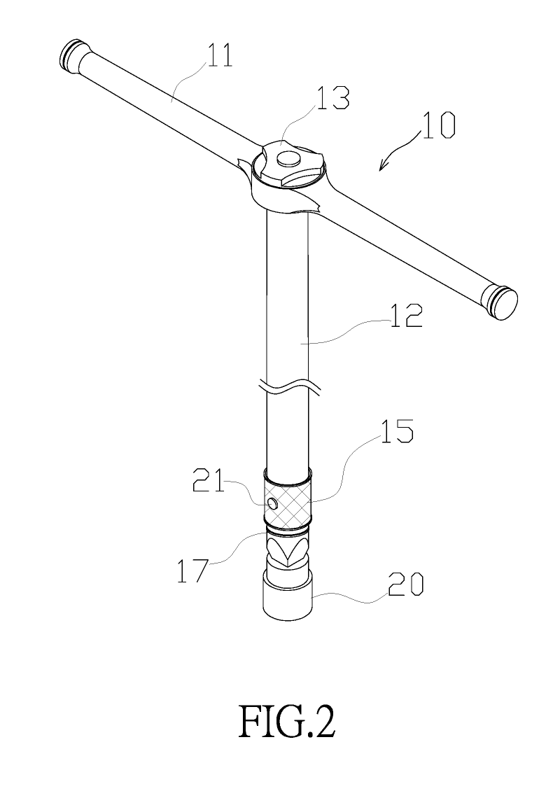

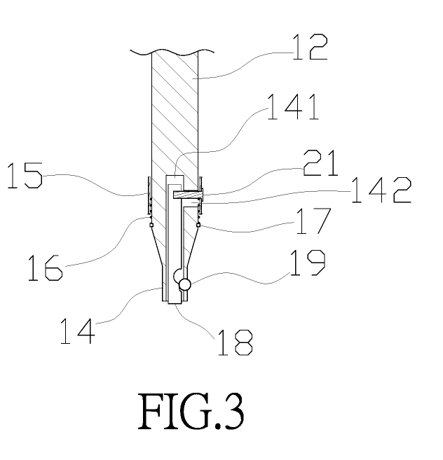

With reference to FIGS. 1, 2 and 3 for a ratchet wrench of a preferred embodiment of the present invention, the ratchet wrench 10 is comprised of a transverse force applying handle 11 and a longitudinal acting handle 12, and a ratchet steering and a driving mechanism 13 are installed at a junction of the two handles 11, 12 and provided for controlling a force applying direction, wherein a substantially polygonal plug end 14 of the acting handle 12 has a quick release structure comprised of a sliding sleeve 15, an elastic member 16, a buckle 17, a top shaft 18 and a latching bead 19, and the sliding sleeve 15 may be displaced to prop out a latching bead 19 or sink the latching bead 19 to achieve the effect of plugging an external connected assembling member 20 (such as a socket as shown in the figures) or separating the assembling member 20 quickly.

Wherein, an axial deep hole 141 is formed at the plug end 14 of the acting handle 12 and provided for receiving the top shaft 18, and a long pin slot 142 is formed at the top side of the plug end 14 and communicated with the deep hole 141, and a bead hole 143 is formed on a side of the plug end 14 and provided for receiving the latching bead 19, and the sliding sleeve 15 is sheathed on the external periphery of the acting handle 12 and a through hole 151 is formed on a side of the sliding sleeve 15 and provided for passing a positioning pin 21 into the long pin slot 142 to latch a corresponsive latch slot 181 of the top shaft 18 directly to define a link relation, and the buckle 17 is latched into a corresponsive fastening slot 144 of the acting handle 12, and the elastic member 16 is installed between the buckle 17 and the sliding sleeve 15, and a latch slot 181 and a stepped bead slot 182 are formed at both top and bottom ends of the top shaft 18 respectively.

With the aforementioned components, the elastic member 16 normally props the sliding sleeve 15 by its own elastic force. Now, the top shaft 18 is moved upwardly to prop the latching bead 19 by a stepped bead slot 182. If the sliding sleeve 15 is pushed to move downward, then the top shaft 18 will move downward accordingly, so that the latching bead 19 is situated at a released position. In other words, users simply push the sliding sleeve 15 downward to set the latching bead 19 to a sinking position when it is necessary to plug or separate the external connected assembling member 20. After the external force is eliminated, the latching bead 19 is resumed to its propped-out position, so as to latch the external connected assembling member 20 securely and prevent it from falling out effectively.

Since the ratchet steering and driving mechanism 13 is a prior art that is used extensively as a specific steering and driving unit of a hand tool, and thus will not be described in details.

Many changes and modifications in the above-described embodiments of the invention can, of course, be carried out without departing from the scope thereof Accordingly, to promote the progress in science and the useful arts, the invention is disclosed and is intended to be limited only by the scope of the appended claims.

1. A quick release structure of a T-shaped ratchet wrench having a longitudinal acting handle with a substantially polygonal plug end, the quick release structure comprising:
a sliding sleeve sleeved onto an outer surface of the longitudinal acting handle,
a C-clip engaged in a circumferential groove formed in the outer surface of the longitudinal acting handle,
an elastic member sleeved onto the outer surface of the longitudinal acting handle and interposed between the sliding sleeve and the C-clip so as to exert an extensive force therebetween,
a top shaft connected to the sliding sleeve, and
a latching bead engaged with the top shaft such that longitudinal displacement of the sliding sleeve extends or retracts the latching bead to secure or release an external connected assembling member.

2. The quick release structure of a T-shaped ratchet wrench according to claim 1, wherein the plug end of the acting handle has an axial deep hole receiving the top shaft, and a long pin slot formed on a top side of the plug end and communicated with the deep hole, and a bead hole formed on a side of the plug end receiving the latching bead, and a through hole is formed on a side of the sliding sleeve with a positioning pin extending into the long pin slot and latching into a corresponsive latch slot of the top shaft to define a link relation and a latch slot and a stepped bead slot are formed at both top and bottom ends of the top shaft respectively.
